(19) United States
(12) Patent Application Publication
(10) Pub. No.: US 2002/0039449 A1
(43) Pub. Date: Apr. 4, 2002

(54) Image compression apparatus

(76) Inventor: Shigetoshi Nouda, Kanagawa (JP)

Correspondence Address: FROMMER LAWRENCE & HAUG LLP, 745 FIFTH AVENUE, NEW YORK, NY, 10151, US

(21) Appl. No.: 09/940,347

(22) Filed: Aug. 27, 2001

(30) Foreign Application Priority Data
Aug. 28, 2000 (JP) P2000-257767

(51) Int. Cl. G06K 9/46; G06K 9/36

(52) U.S. Cl. 382/238

(57) ABSTRACT

A special transformation type context model encoder is supplied with an image signal and performs encoding processing according to context modeling. A transformation prediction difference processor subjects an appropriate referable pixel to special reversible S transformation, which is transformation including shift transformation and constant-range transformation and using an appropriate transformation coefficient that satisfies a condition for reversibility, and thereby calculates an initial prediction value. The transformation prediction difference processor also quantizes context after the special reversible S transformation. A prediction error calculator makes prediction correction of the initial prediction value according to the quantized context and then calculates a difference between the prediction value and a pixel to be predicted to encode an image signal. An entropy encoding compressor subjects the encoded image signal to entropy encoding to thereby generate a compressed image signal. In this case, the context is reflected in the entropy encoding as required.

### BACKGROUND OF THE INVENTION

The present invention relates to an image compression apparatus, and particularly to an image compression apparatus that performs reversible image compression, which preserves original information after processes of compression and expansion.

Conventionally, as methods of compressing a color still image, there are a reversible image compression (reversible encoding) method, which can preserve original information even after processes of compression and expansion, and a non-reversible encoding method, which causes some distortion in the processes of compression and expansion and therefore does not restore the image completely. In general, the latter, which can achieve high compression rates, is widely used. However, higher image quality such as higher resolution (1000 pixels*1000 pixels or more) of a digital still camera has recently been required, and therefore there is a need for reversible image compression that does not degrade the image even after processes of image archiving (DB), transfer, editing and the like. In some applications such as images for medical use, degradation in image quality cannot be tolerated. There is not yet an image compression method capable of sufficiently high compression rates for these applications.

An image compression apparatus using a conventional reversible image compression method will be described. FIG. 6 is a configuration diagram of an image compression apparatus using a conventional reversible image compression method. The conventional image compression apparatus comprises: an adaptive switching type prediction difference processor 500 for calculating a prediction error; and an entropy encoding compressor 600 for entropy encoding of the prediction error. The adaptive switching type prediction difference processor 500 is supplied with an image signal, selects a calculation mode that provides the least difference among differences between a target pixel and prediction values predicted from several peripheral pixels, and then calculates a prediction error in the selected calculation mode. The entropy encoding compressor 600 subjects the prediction error calculated by the adaptive switching type prediction difference processor 500 to variable-length encoding such as Huffman coding or arithmetic coding, and then outputs compressed code.

Prediction difference processing performed by the adaptive switching type prediction difference processor 500 will be described. The prediction difference processing selects a calculation mode that provides the least difference among differences between a target pixel I_x and prediction values P_x predicted from its peripheral pixels, and then calculates a difference signal Er in the selected calculation mode. This processing will be described by taking a concrete example. FIG. 7 is a pre-prediction relational diagram showing an arrangement of peripheral pixels and a target pixel. When a known peripheral pixel is represented by x_u_v (u and v are arbitrary integers), a prediction value P_x can be expressed as:

### Equation 1 P_{—}x=Predict{x_{—}u_{—}v} (1)

where Predict{ } is a prediction function for calculating a prediction value. Letting SV be a special code (adaptive code) indicating a selected calculation mode, the following equations, for example, are determined:

### Equation 2

$$\begin{matrix}If P1 = x\_ 1 \_ 0 , SV = 1 , \\ If P2 = x\_ 0 \_ 1 , SV = 2 , \\ If P3 = Integer \{ ( x\_ 1 \_ 0 + x\_ 0 \_ 1 ) / 2 \} , SV = 3\end{matrix} \qquad ( 2 )$$

where Integer{ } is an integral function. The adaptive switching type prediction difference processing selects a prediction value of the least error from the prediction values P1, P2, and P3, and then adds a special code SV indicating a then selected calculation mode.

When setting the selected prediction value to be SV_x=Selection{P_x}, a prediction error Er is obtained by the following equation:

### Equation 3 Er=I_{—}x−SV_{—}x (3)

Then, there is a context modeling method in which prediction correction is made according to context of an appropriate known peripheral pixel and the context is reflected in entropy encoding according to the context as required. When letting C_x be a context correction value calculated from an appropriate known peripheral pixel and adding the context correction value to the equation (3), the prediction error Er is:

### Equation 4 Er=I_{—}x−SV_{—}x+C_{—}x (4)

This is an effective method when peripheral context has correlation, as in the case of a nature image.

However, the image compression apparatus carrying out the conventional reversible image compression method as described above cannot increase its compression rate.

According to the reversible image compression method as described above, the calculation mode is changed for each appropriate scan block, for example each scan line. Thus, this adaptive processing is incomplete as adaptive processing because the processing is not adapted to each pixel. In addition, since the calculation mode is fixed in one scan block, the difference may become large depending on the pixel, thereby resulting in poor prediction accuracy. Therefore, the adaptive processing for scan block units does not much contribute to improvement in compression rate.

On the other hand, when the adaptive processing is performed for each pixel and a special code is added to each pixel, the number of information bits is increased, so that the compression rate is not necessarily improved.

Thus, some prediction processing methods use a fixed pattern to select the calculation mode. For example, there is a method of selecting the calculation mode of a prediction value Px according to a result of comparison between values of the above-mentioned peripheral pixels x_{—}1_{—}0, x_{—}0_{—}1, and x_{—}1_{—}1. An example of the method will be given in the following. The peripheral pixel x_{—}1_{—}1 is compared with the peripheral pixels x_{—}1_{—}0 and x_{—}0_{—}1, and then

### Equation 5 If x_{—}1_{—}1 is greater than (x_{—}1_{—}0, x_{—}0_{—}1), Px=min(x_{—}1_{—}0, x_{—}0_{—}1)

If x_{—}1_{—}1 is less than (x_{—}1_{—}0, x_{—}0_{—}1), Px=max(x_{—}1_{—}0, x_{—}0_{—}1)

Otherwise Px=(x_{—}1_{—}0 +x_{—}0_{—}1)/2 (5)

The above equations are set to calculate the prediction value Px. In the equations, min(x_{—}1_{—}0, x_{—}0_{—}1) indicates selecting either x_{—}1_{—}0 or x_{—}0_{—}1, whichever is less, and max(x_{—}1_{—}0, x_{—}0_{—}1) indicates selecting either x_{—}1_{—}0 or x_{—}0_{—}1, whichever is greater. The method has many variations, and the processing is determined on the basis of various evaluations. However, the processing is not optimum processing adapted to the characteristic of an actual image, and therefore prediction accuracy may be poor.

Furthermore, even when the context modeling processing is performed, prediction accuracy is poor, and therefore a result of the context modeling processing also becomes poor.

Thus, the conventional reversible image compression cannot improve prediction accuracy, and hence it is difficult to improve compression rate. Also, there is an obstacle to compression rate improvement, such as the need to add special codes.

### SUMMARY OF THE INVENTION

The present invention has been made in view of such problems, and it is accordingly an object of the present invention to provide an image compression apparatus that can improve compression rate of reversible image compression.

In order to solve the above problems, according to the present invention, there is provided an image compression apparatus for performing reversible image compression, which preserves original information after processes of compression and expansion, the image compression apparatus having a special transformation type context model encoding means for generating a compressed image signal. The special transformation type context model encoding means comprises: a transformation prediction difference processing means for receiving an image signal and subjecting a referable pixel present around the periphery of a pixel to be predicted to special reversible S (Sequential) transformation, which is transformation including shift transformation and constant-range transformation and using an appropriate transformation coefficient that satisfies a condition for reversibility, according to context modeling that performs adaptive processing on the basis of context of the referable peripheral pixel, thereby calculating an initial prediction value of the pixel to be predicted, and also quantizing the context after the special reversible S transformation; a prediction error calculating means for performing prediction correction on the basis of the context and then calculating a prediction error to encode the image signal; and an entropy encoding means for subjecting the encoded image signal to entropy encoding.

In the thus formed image compression apparatus, the special transformation type context model encoding means receives an image signal and performs encoding processing according to context modeling that performs adaptive processing on the basis of context of the referable pixel present around the periphery of the pixel to be predicted. The transformation prediction difference processing means forming the special transformation type context model encoding means subjects the appropriate referable pixel to the special reversible S transformation, which is transformation including shift transformation and constant-range transformation and using an appropriate transformation coefficient that satisfies a condition for reversibility, and thereby calculates the initial prediction value. The transformation prediction difference processing means also quantizes the context after the special reversible S transformation. The prediction error calculating means makes prediction correction of the initial prediction value according to the quantized context and then calculates a difference between the prediction value and the pixel to be predicted to encode the image signal. The entropy encoding means subjects the encoded image signal to entropy encoding to thereby generate a compressed image signal. In this case, the context is reflected in the entropy encoding as required.

In order to solve the above problems, according to the present invention, there is provided an image compression method for performing reversible image compression, which preserves original information after processes of compression and expansion. The image compression method comprises the steps of: receiving an image signal and subjecting a referable pixel present around the periphery of a pixel to be predicted to special reversible S transformation, which is transformation including shift transformation and constant-range transformation and using an appropriate transformation coefficient that satisfies a condition for reversibility, according to context modeling that performs adaptive processing on the basis of context of the referable peripheral pixel, thereby calculating an initial prediction value of the pixel to be predicted, and also quantizing the context; making adaptive correction of the initial prediction value of the pixel to be predicted using the context and then calculating a prediction error to encode the image signal; and subjecting the encoded image signal to entropy encoding, which reflects the context as required, to thereby generate a compressed image signal.

The image compression method comprising the above steps receives an image signal and subjects the referable pixel present around the periphery of the pixel to be predicted to the special reversible S transformation, which is transformation including shift transformation and constant-range transformation and using an appropriate transformation coefficient that satisfies a condition for reversibility, according to context modeling that performs adaptive processing on the basis of context of the referable peripheral pixel, and thereby calculates the initial prediction value of the pixel to be predicted. Also, the image compression method quantizes the context and makes prediction correction of the initial prediction value according to the quantized context. The image compression method subjects the thus encoded image signal to entropy encoding, which reflects the context as required, to thereby generate a compressed image signal.

### BRIEF DESCRIPTION OF THE DRAWINGS

FIG. 1 is a configuration diagram of an image compression apparatus according to an embodiment of the present invention;

FIG. 2 is a diagram of a 2*2-matrix Ladder Network structure;

FIG. 3 is a diagram of a structure generalized by Leapflog structure;

FIG. 4 shows an arrangement of peripheral pixels and a pixel to be predicted of an image processed by the image compression apparatus according to the embodiment of the present invention;

FIG. 5 is a flowchart of an image compression method according to an embodiment of the present invention;

FIG. 6 is a configuration diagram of an image compression apparatus using a conventional reversible image compression method; and

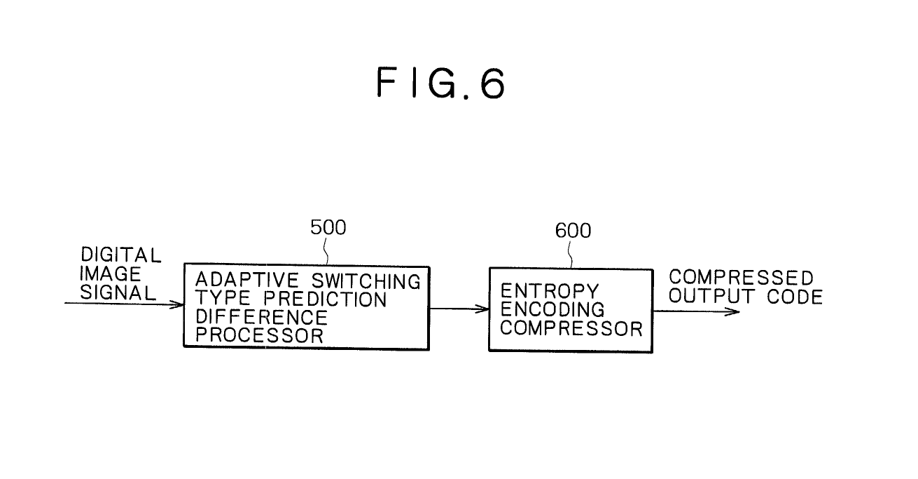

FIG. 7 is a pre-prediction relational diagram showing an arrangement of peripheral pixels and a target pixel.

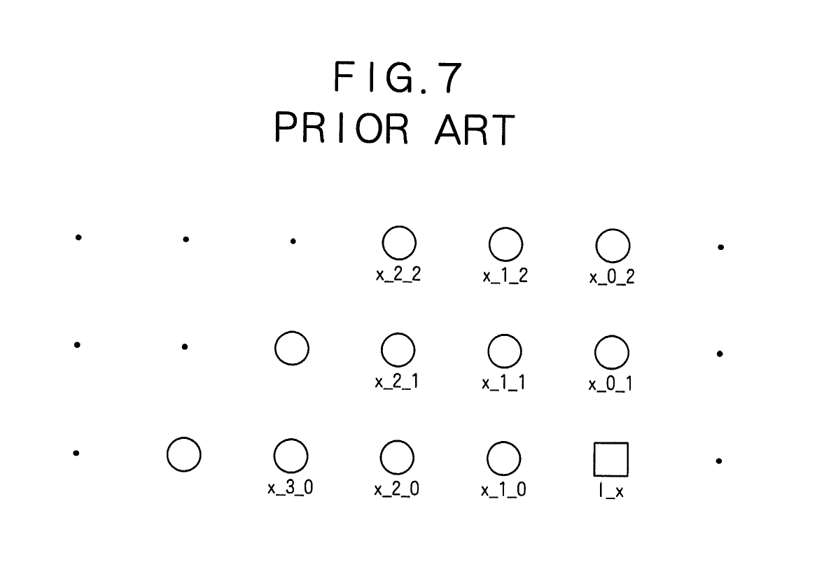

### DETAILED DESCRIPTION OF THE INVENTION

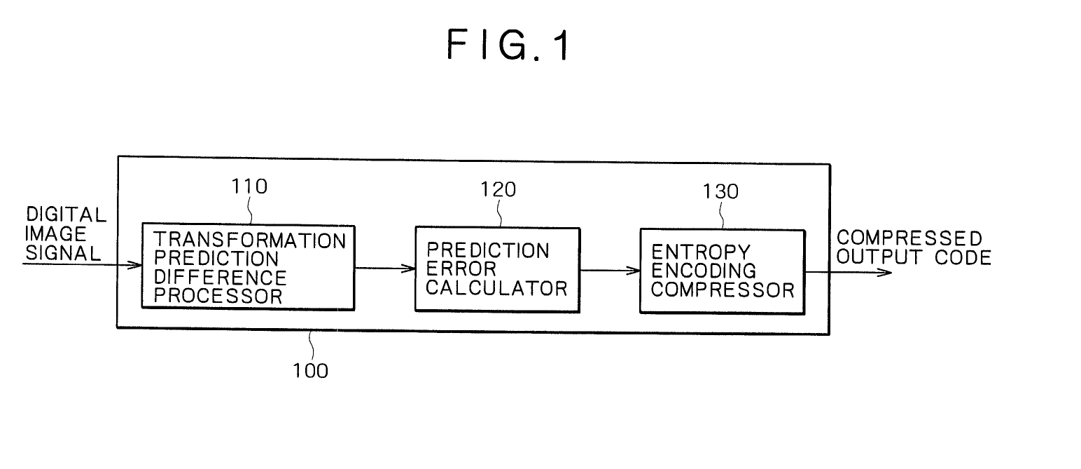

Preferred embodiments of the present invention will hereinafter be described with reference to the drawings. FIG. 1 is a configuration diagram of an image compression apparatus according to an embodiment of the present invention.

The image compression apparatus according to the present invention is supplied with a digital image signal and then generates a compressed image signal by means of a special transformation type context model encoder 100, which encodes an image signal according to context modeling that performs adaptive processing on the basis of context of a referable pixel present around the periphery of a pixel to be predicted.

The input digital image signal is for example a signal obtained by image pickup by a CCD digital camera or full color CG (including characters).

The special transformation type context model encoder 100 comprises: a transformation prediction difference processor 110 for performing special reversible S transformation and thereby calculating an initial prediction value and context; a prediction error calculator 120 for calculating a prediction error after prediction correction; and an entropy encoding compressor 130 for subjecting an encoded image signal to entropy encoding. The processes of these parts are carried out by a coefficient subjected to appropriate special transformation processing, and are correlated with each other.

The transformation prediction difference processor 110 subjects the peripheral referable pixel to special reversible S (Sequential) transformation, which is transformation including shift transformation and constant-range transformation and using an appropriate transformation coefficient that satisfies a condition for reversibility. The transformation prediction difference processor 110 thereby calculates an initial prediction value of the pixel to be predicted. Also, the transformation prediction difference processor 110 quantizes peripheral context for context modeling. In addition, the transformation prediction difference processor 110 subjects a variable after special reversible S transformation to optimum adaptive processing as required.

Special reversible S transformation will first be described. The special reversible S transformation refers to reversible S transformation, which performs transformation processing using an appropriate transformation coefficient that satisfies a condition for reversibility, and transformation that performs shift transformation processing and constant-range transformation processing for maintaining a constant range.

General equations of reversible S transformation can be expressed as:

### Equation 6 H=round{AI},

I=round{A⁻¹H} (6)

where an image component is N; a transformation coefficient matrix is A; an input image is I; and a transformation output image is H. In this case, it is assumed that A is an N×N coefficient matrix and that A⁻¹ exists. Further, round{f(x)} represents a function that makes a function f(x) an integral function.

Shift transformation processing shifts a function f(x) to f(x−α)−β by using arbitrary α and β. Such shift processing will be referred to as s processing, and the s processing of an element a will hereinafter be expressed as (a), s.

Constant-range transformation processing is intended to maintain a constant range. The constant-range transformation processing will hereinafter be expressed as m{ }. Also, inverse m{ } will be expressed as im{ }.

When letting B be A⁻¹, expressing each element by a lower-case letter, and letting n be an element number and (n, m) be the B and A matrixes, the special reversible S transformation srs{ }, which includes the reversible S transformation of the equations (6), can be expressed as:

### Equation 7 h_{—}n=round{srs{round{m{(a_{—}n_{—}m_{—}i_{—}n), s}}}},

i_{—}n=round{srs{round{im{(b_{—}n_{—}m_{—}h_{—}n), s}}}} (7)

These are fundamental transformation structure equations of the special reversible S transformation according to the present invention. There are various transformations having this structure; however, the special reversible S transformation in this case refers to all of the transformations, and is not specifically limited to one equation. When the equations (7) are determined adaptively, the transformation calculation may of course be controlled for optimum adaptive processing, which will be described later. As a determination method for satisfying reversibility, there is a well-known method using Ladder Network and Leapflog structure; however, the present invention is not specifically limited to the method.

For convenience, round{srs{round{ }}} will hereinafter be described as rsr{ }.

Special reversible S transformation prediction extension is possible by adding prediction correction to the special reversible S transformation described above. When prediction processing P_n is added to the special reversible S transformation expressed by the equations (7) and extension transformation is represented by “′”, the following expression is obtained.

### Equation 8 h_{—}n=round{srs′{round{m{(a_{—}n_{—}m_{—}n, P_{—}n), s}}}},

i_{—}n=round{srs′{round{im{(b_{—}n_{—}m_{—}h_{—}n, P_{—}n), s}}}} (8)

These are fundamental prediction type transformation structure equations of the special reversible S transformation according to the present invention. There are various transformations having this structure; however, the special reversible S transformation in this case refers to all of the transformations, and is not specifically limited to one equation. Of course, when the equations (8) are determined adaptively, the prediction calculation may also be controlled for optimum adaptive processing, which will be described later. The prediction processing P may be simple peripheral prediction; for the highest performance, however, it is desirable to perform prediction processing in association with the optimum adaptive processing to be described later.

For convenience, round{srs′{round{ }}} will hereinafter be described as rsr{ }. Also, a combination of rsr{ } and rs′r{ } will be expressed as RSR{ } in capital letters.

A case of two components of the special reversible S transformation will be illustrated in the following. The following expression is obtained from the equations (7) and the equations (8).

### Equation 9 h_{—}1=RSR{m{(a_{—}1_{—}mi_{—}1, P_{—}1), s}},

h_{—}2=RSR{m{(a_{—}2_{—}mi_{—}2, P_{—}2), s}},

i_{—}1=RSR{im{(b_{—}1_{—}mh_{—}1, −P_{—}1), s}},

i_{—}2=RSR{im{(b_{—}2_{—}mh_{—}2, −P_{—}2), s}} (9)

For reversibility, a_{—}1_m, a_{—}2_m, b_{—}1_m, b_{—}2_m, and s are properly determined. As a determination method for satisfying reversibility, there is a well-known method using Ladder Network and Leapflog structure; however, the present invention is not limited to the method.

When the relation of the prediction calculations is a simple linear combination, calculation of the equations (9) can be simplified, and thus the following equations are obtained.

### Equation 10 h_{—}1=RSR{m{(Σa_{—}1_{—}m i_{—}1+P_{—}1), s}},

h_{—}2=RSR{m{(Σa_{—}2_{—}m i_{—}2+P_{—}2), s}},

i_{—}1=RSR{im{(Σb_{—}1_{—}m h_{—}1−P_{—}1), s}},

i_{—}2=RSR{im{(Σb_{—}2_{—}m h_{—}2−P_{—}2), s}} (10)

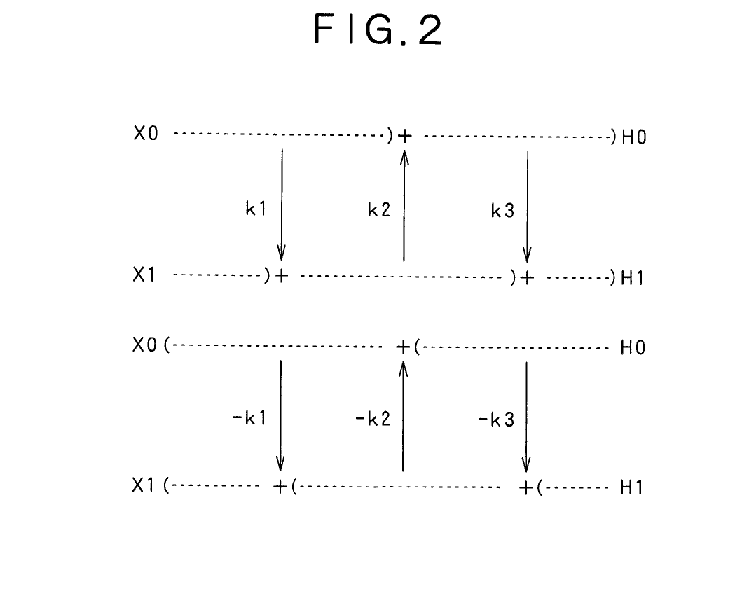

The determination method using Ladder Network and Leapflog structure will be described. FIG. 2 is a diagram of a 2*2-matrix Ladder Network structure.

As normalization ad−bc=1 in 2*2 matrixes in general matrix transformation H=AX, transformation coefficient matrixes A and A⁻¹ can be expressed as:

### Equation 11

$$\begin{matrix}A = [ \begin{matrix}a & b \\ c & d\end{matrix} ] = [ \begin{matrix}1 & 0 \\ ( d - 1 ) / b & 1\end{matrix} ] [ \begin{matrix}1 & b \\ 0 & 1\end{matrix} ] [ \begin{matrix}1 & 0 \\ ( a - 1 ) / b & 1\end{matrix} ] & ( 11 ) \\ {A}^{- 1} = [ \begin{matrix}1 & ( 1 - a ) / b \\ 0 & 1\end{matrix} ] [ \begin{matrix}1 & 0 \\ - b & 1\end{matrix} ] [ \begin{matrix}1 & ( 1 - d ) / b \\ 0 & 1\end{matrix} ] & \end{matrix}$$

When setting k1=(a−1)/b, k2=b, and k3=(d−1)/b, the Ladder structure of FIG. 2 is realized. Such structure is referred to as Ladder Network.

These equations are reversible even when changed into integral functions as follows.

### Equation 12 Q=round{X1+c0×0 +½}, c0=k1

H0=round{X0+c1Q+1/2}, c1 =k2

H1=round{Q+c2H0+½}, c2=k3 (12)

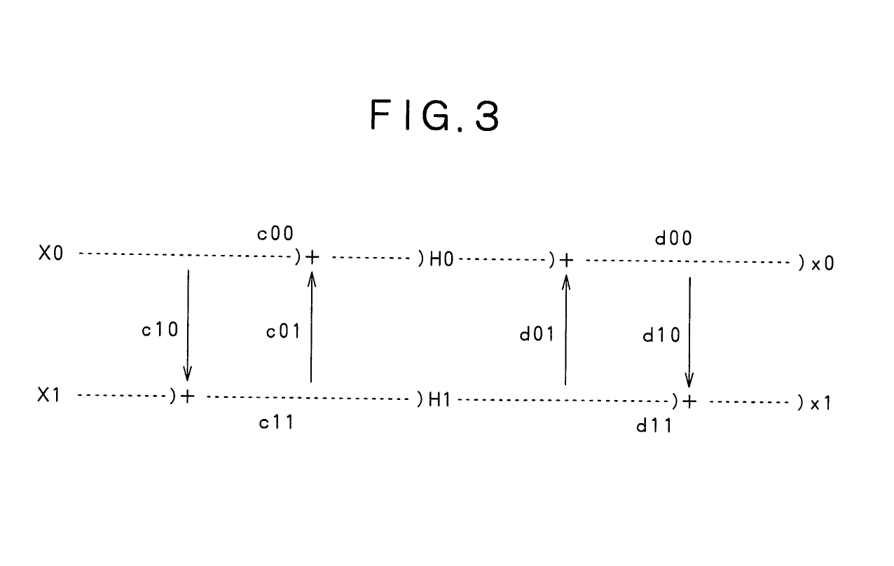

These equations can be generalized by Leapflog structure. FIG. 3 is a diagram of a structure generalized by the Leapflog structure. Thus, the following are derived.

### Equation 13 H0=(c00+c10c11c01)×0+c11c01×1,

H1=c10c11×0+c11×1,

x0=d00H0+d00d01 H1,

x1=d00d10H0+(d11+d01d00d10)H1 (13)

Conditions for reversibility are: c00d00=c11d11=1; c01=−d01; and c10=−d10.

Second, optimum adaptive processing will be described. The special reversible S transformation may further include the optimum adaptive processing as required. The optimum adaptive processing calculates an optimum adaptive function that maximizes rating of correlation between elements. A fundamental method of the optimum adaptive processing will be described.

The optimum adaptive processing first rates correlation between elements. The correlation rating is calculated by a degree of inter-element similarity Sm or distance Dm to select an optimum value and a method. Optimum selection function transformation SP is obtained by processing from a set of peripheral elements that maximizes rating of the degree of similarity. Optimum selection function transformation SP of a general calculation type can be expressed with a function f in the neighborhood of P as:

### Equation 14 SP=round[f(Select {x_{—}p}) for max{Sm}] (14)

In the case of distance Dm, the optimum selection function transformation SP is obtained by processing from a set of peripheral elements that minimizes rating of the distance. As in the case of the degree of similarity Sm, the following expression is obtained.

### Equation 15 SP=round[f(Select{x_{—}p}) for min{Dm}] (15)

The optimum selection function transformation SP is outputted by the operation output function f of the selection element (x_p), and provides an integral function output. This function exists in various forms, and the present invention is not limited to one specific form.

When f( ) can be expressed by a linear function with a parameter p and a maximum weighting factor w_p, the optimum selection function transformation SP is equivalent to:

### Equation 16 SP=round{[p: a to d]Σw_{—}p*x_{—}p} (16)

Thus, the maximum weighting factor w_p varies according to the characteristic of the degree of inter-element similarity. However, in order to make its dynamic range the same as that of elements, normalization is carried out to set [p: a to d]Σwp=1.

The optimum adaptive processing described above is combined with the special reversible S transformation. First, as a simple combination, an element of optimum prediction is combined as a P-neighborhood special reversible S transformation coefficient H_p. This is optimum adaptive processing of a transformation coefficient subjected to the special reversible S transformation as the element. When the P-neighborhood special reversible S transformation coefficient H_p is applied to the equation (14) or the equation (15), the following is obtained.

### Equation 17 SP=round[f(Select{H_{—}p}) for max{Sm}]

or

SP=round[f(Select{H_{—}p}) for min{Dm}] (17)

In addition, optimum combination is possible by adding a predetermined representative coefficient that maximizes the degree of inter-element similarity Sm or minimizes the distance Dm. Similarly to the equation (17), when letting A and B be a representative coefficient, an optimum combination with the special reversible S transformation can be expressed as:

### Equation 18 SP=round[(Select{H_{—}p, A or B}) for max{Sm}]

or

SP=round[(Select{H_{—}p, A or B}) for min{Dm}] (18)

Although this equation is very complex and a procedure for calculating reversible A and B satisfying the equation is complicated, the equation can enhance the performance most. For simpler processing, there is a method of including several representative coefficients (A, B) in a code book and making selections from the representative coefficients. An appropriate calculating method is selected, and the present invention does not specify the calculating method.

Third, determination of context and quantization will be described. Quantization and determination of context associated with a transformation coefficient after the special reversible S transformation and context adaptive correction of an optimum prediction value will be described in the following.

Generally, there is a concentration gradient and the like in the neighborhood of p as context of an input element x_p in the neighborhood of p. When it is assumed that the number of kinds of contexts is Cr and a quantization coefficient is Cq, the total number of contexts Ct is Cr*Cp. In the case of a concentration gradient, the halving of contexts due to similarity between a positive and a negative gradient pattern is known. Although the present invention does not specify these methods, the present invention employs context using a transformation coefficient.

Simple quantization of transformation coefficient context Cts will be described. In this case, context of the transformation coefficient H_p obtained earlier in a simple manner is extracted and quantized. In the case of a concentration gradient Δ, when it is supposed that the p neighborhood and its adjacent coefficient set are (H_r_p, H_r_p′), halving processing is represented with an absolute value expression (enclosed by ||) and a context inversion sign PC.

### Equation 19 Δ_{—}r_{—}p=H_{—}r_{—}p−H_{—}r_{—}p′,

Cts_{—}r_{—}p=|Δ_{—}r_{—}p|,

PC=Sign{Δ_{—}r_{—}p} (19)

When transformation coefficient distribution differs greatly by the transformation processing, it is advantageous to appropriately determine context according to the transformation coefficient distribution. Such coefficient-dependent extension context Cth will be described. When the transformation coefficient distribution differs greatly by the transformation processing, context quantization is changed for every appropriate n transformations.

### Equation 20 Cth_{—}r_{—}p_{—}n=|H_{—}r_{—}p_{—}n−H_{—}r_{—}p_{—}n′|,

PC=Sign{H_{—}r_{—}p_{—}n−H_{—}r_{—}p_{—}n′} (20)

An expression combining Cts and Cth will be described as Ctx.

Next, the prediction error calculator 120 will be described. The prediction error calculator 120 in this case makes adaptive correction of an initial prediction value using quantized context and calculation of a prediction error.

At a position x, let I_x be the pixel to be predicted, OP_x be the optimum prediction value calculated by the transformation prediction difference processor 110 described above, C_x be a context correction value calculated from quantized context Ctx, and Er be a prediction error. Then, encoding can be expressed as:

### Equation 21 Er=I_{—}x−OP_{—}x+C_{—}x (21)

Decoding is:

### Equation 22 I_{—}x=Er+OP_{—}x−C_{—}x (22)

Next, the entropy encoding compressor 130 will be described. The entropy encoding compressor 130 in this case subjects an encoded image signal to entropy encoding processing. The encoded signal that has been subjected to the special reversible S transformation, optimum adaptive prediction, and context correction processing is reduced in image entropy. When the image signal is encoded by appropriate entropy encoding processing, the image signal can be compressed at a high compression rate. Huffman coding, arithmetic coding, Golomb-Rice coding and the like are known as the entropy encoding processing. In the present invention, either one of these methods is suitably selected, and therefore the present invention does not specify the processing method. Of course, however, it is most appropriate to select an encoder suitable for a context model.

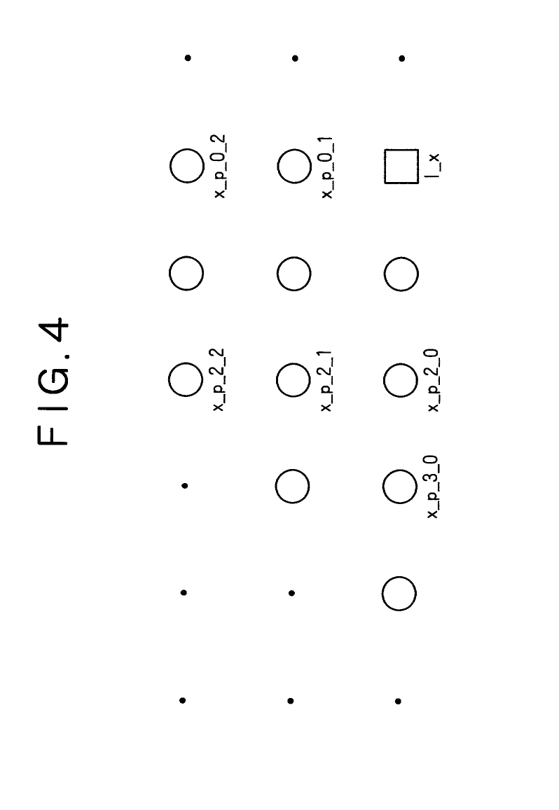

Operation of the image compression apparatus thus formed will be described. FIG. 4 shows an arrangement of peripheral pixels and a pixel to be predicted of an image processed by the image compression apparatus according to an embodiment of the present invention. Suppose that the pixel to be predicted is I_x, and a known pixel is x_p (p=p_U_v, where u and v are arbitrary integers).

The transformation prediction difference processor 110 performs the special reversible S transformation, the optimum adaptive prediction processing, and the context quantization. In this case, the transformation prediction difference processor 110 performs the optimum adaptive processing by the degree of similarity. When the special reversible S transformation is represented by H{ }, the degree of similarity Sm after the special reversible S transformation can be expressed as:

### Equation 23 Sm=Similarity{H(x_{—}p)} (23)

On the basis of the degree of similarity Sm, an optimum element set SP that maximizes rating of correlation between elements can be expressed as:

### Equation 24 SP=Select{H{x_{—}p}} for max{Sm} (24)

On the basis of the above, optimum adaptive prediction OP is:

### Equation 25 OP=round{f(SP)} for max{Sm} (25)

Context after the special reversible S transformation is extracted and quantized. The prediction error calculator 120 calculates an optimum prediction error OEr from the optimum adaptive prediction OP and a context correction value C_x calculated from the context. The encoding can be expressed as:

### Equation 26 OEr=I_{—}x−OP_{—}x+C_{—}x (26)

The entropy encoding compressor 130 subjects the image signal thus encoded to entropy encoding compression processing to thereby generate a compressed image signal.

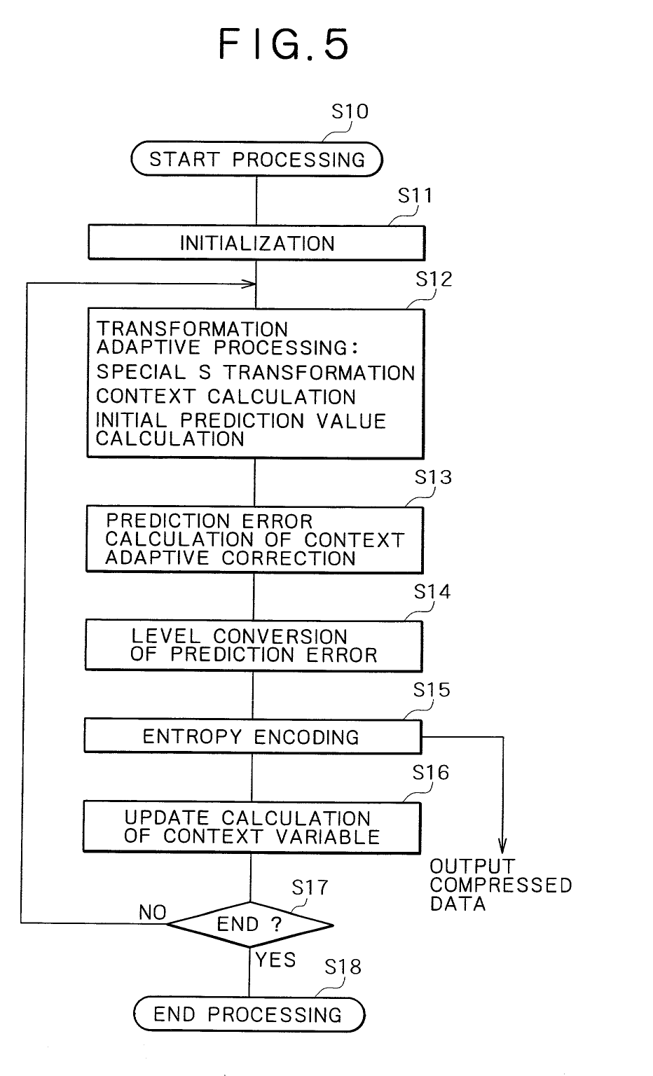

An image compression method according to the present invention will next be described. FIG. 5 is a flowchart of an image compression method according to an embodiment of the present invention.

When compression processing is started (S10), initialization (S11) is performed. The initialization of a sum of prediction error values Sum[s][Cn], a histogram H[Cn], and a prediction correction value Corr[Cn] is performed for each context (Ctx), where s is a mode parameter and Cn is a context number. The context is obtained by quantizing the characteristic of known peripheral pixel concentration into n sets. A concentration gradient and the like are known as the characteristic; however, the present invention does not specify the characteristic.

Next, transformation adaptive processing is performed (S12). At this step, the special reversible S transformation, the context extraction, and the prediction and difference calculation processing are performed in association with each other. At a position x, a special reversible S transformation coefficient H_x is obtained from the pixel I_x. Let SRS(x) be a special reversible S transformation function and SRSi(x) be an inverse transformation function. Then, from the equation (7), encoding is:

### Equation 27 H_{—}x=SRS(x)=RSR{m{(a_{—}n_{—}m i_{—}n, P_{—n}), s}}_{—}x (27)

Decoding is:

### Equation 28 I_{—}x=SRSi(x)=RSR{im{(b_{—}n_{—}m h_{—}n, P_{—}n), s}}_{—}x (28)

Next, an initial prediction value is calculated. In the initial prediction value calculation, when letting Predict be a prediction value calculation function, the initial prediction value P_x in the p-neighborhood of the position x is expressed as:

### Equation 29 P_{—}x=Predict(H_{—}x_{—}p) (29)

where H_p is an appropriate peripheral transformation function element. The present invention includes prediction calculation from all transformation coefficients including the optimum prediction calculation processing described above. In the case of the optimum prediction processing, under the optimum of maximum similarity Sm, for example, the prediction function Predict (H_p) is expressed with a function f of an optimum selection function Select as follows:

### Equation 30 Predict (H_{—}p)=round(f(Select(H_{—}p))) for max(Sm(H_{—}p)) (30)

The equation in the case of distance is the same as the above and therefore will be omitted.

Next, context calculation is performed. When a p-neighborhood concentration gradient Δ_c of the transformation coefficient H_x is used as peripheral pixel context, context Cn is:

### Equation 31 Cn=Ctx(Δ) (31)

C is determined by an appropriate number (r_p_n) for context reference.

Next, prediction error calculation of context adaptive correction is performed (S13). A prediction error Er is calculated by using the prediction correction value Corr[Cn]. At a position x, encoding is performed by:

### Equation 32 Er=H_{—}x−P_{—}x+Corr[Cn] (32)

Decoding is performed by:

### Equation 33 H_{—}x=Er+P_{—}x−Corr[Cn] (33)

Next, as preprocessing for entropy encoding, level conversion of the prediction error Er is performed (S14). In encoding, the prediction error after level conversion is set to be CEr=ConvL (Er). In decoding, the prediction error after level conversion is set to be Er=ConvL⁻¹(Cer). Any modulo reduction method may be used as these methods.

Next, entropy encoding is performed (S15). When a compressed image signal is represented by OutCode and entropy encoding/decoding is represented by a function Entr( ), encoding can be expressed as:

### Equation 34 OutCode=Entr(CEr(Cn)) (34)

Decoding can be expressed as:

### Equation 35 CEr(Cn)=Entr⁻¹(OutCode) (35)

Encoded compressed data is outputted.

Then, for the next processing, update calculation of context variables is performed (S16) The sum of prediction error values Sum[s][Cn] and the histogram H[Cn] are updated. Also, the prediction correction value Corr[Cn] is calculated by a correction function Correct( ).

### Equation 36 Corr[Cn]=Correct(Cn, Sum[ ][ ], H[ ]) (36)

Next, whether the end of the image has come, that is, whether the processing is to be ended is checked (S17). When the end of the image has not come, the processing returns to S12 to repeat processes from the transformation adaptive processing down. When the end of the image has come, the processing is ended (S18).

An image compression method using a conventional reversible coding system can compress an image to about ½ at the highest compression rate. On the other hand, the present invention combines the special reversible S transformation and the context modeling correction, whereby entropy after encoding is reduced as compared with the conventional method. It is thus possible to compress an image to about ⅓ or less.

The processing functions described above can be realized by a computer. In that case, processes of the functions to be possessed by the image compression apparatus are described in a program recorded on a computer readable recording medium. Then, a computer executes the program, whereby the processes are realized by the computer. Computer readable recording media include magnetic recording media and semiconductor memories. When the program is distributed to the market, the program can be stored on a portable recording medium such as a CD-ROM (Compact Disc Read Only Memory) or a floppy disc for distribution. Alternatively, the program can be stored in a storage device of a computer connected via a network to be thereby transferred to other computers via the network. When a computer executes the program, the program stored on a hard disc or the like within the computer is loaded into main memory and then executed.

As described above, according to the present invention, an image signal is encoded according to context modeling. First, an appropriate referable pixel is subjected to special reversible S transformation including shift transformation and constant-range transformation to thereby calculate an initial prediction value. Also, peripheral context is quantized. Prediction correction is performed on the basis of the context, a prediction error is calculated, and the input image signal is encoded. Then, the encoded image signal is subjected to entropy encoding.

Thus, as a result of reduction of initial information by the special reversible S transformation and the context modeling correction, entropy after encoding is reduced. When the image signal is encoded by an appropriate entropy encoder, the image signal can be compressed at a high compression rate. Thus, reversible image compression capable of high compression performance is made possible.

What is claimed is:

1. An image compression apparatus comprising:
transformation prediction difference processing means for subjecting a referable pixel present around the periphery of a pixel to be predicted to special reversible S (Sequential) transformation, which is transformation including shift transformation and constant-range transformation and using a transformation coefficient that satisfies a condition for reversibility, according to context modeling that performs adaptive processing on the basis of context of the referable peripheral pixel, thereby calculating an initial prediction value of said pixel to be predicted, and also quantizing said context after said special reversible S transformation;
prediction error calculating means for performing prediction correction on the basis of said context and then calculating a prediction error to encode an image signal; and
entropy encoding means for subjecting said encoded image signal to entropy encoding.

2. An image compression apparatus as claimed in claim 1,
wherein said transformation prediction difference processing means further provides prediction correction for said image signal at the time of said special reversible S transformation.

3. An image compression apparatus as claimed in claim 2,
wherein processing of providing said prediction correction makes prediction by optimum adaptive processing using an optimum adaptive processing coefficient that maximizes rating of correlation between referable pixels present around the periphery of said pixel to be predicted and thereby provides the correction.

4. An image compression apparatus as claimed in claim 1,
wherein said transformation prediction difference processing means calculates an optimum adaptive processing coefficient that maximizes rating of correlation between elements of transformation coefficients used when said special reversible S transformation is performed, and performs optimum prediction calculation processing on the basis of said optimum adaptive processing coefficient.

5. An image compression apparatus as claimed in claim 4,
wherein said optimum adaptive processing is performed by adding a representative coefficient that maximizes said rating of correlation.

6. An image compression apparatus as claimed in claim 1,
wherein said transformation prediction difference processing means extracts and quantizes context of the transformation coefficient used when said special reversible S transformation is performed, and thereby calculates transformation coefficient context.

7. An image compression apparatus as claimed in claim 6,
wherein said transformation prediction difference processing means quantizes the context in each predetermined range corresponding to distribution of said transformation coefficient according to said distribution.

8. An image compression method for performing reversible image compression, which preserves original information after processes of compression and expansion, said image compression method comprising the steps of:
subjecting a referable pixel present around the periphery of a pixel to be predicted to special reversible S (Sequential) transformation, which is transformation including shift transformation and constant-range transformation and using a transformation coefficient that satisfies a condition for reversibility, according to context modeling that performs adaptive processing on the basis of context of said referable peripheral pixel, thereby calculating an initial prediction value of said pixel to be predicted, and also quantizing said context;
making adaptive correction of the initial prediction value of said pixel to be predicted using said context and then calculating a prediction error to encode an image signal; and
subjecting said encoded image signal to entropy encoding, which reflects said context as required, to thereby generate a compressed image signal.
